(19) United States
(12) Patent Application Publication
(10) Pub. No.: US 2014/0023867 A1
(43) Pub. Date: Jan. 23, 2014

(54) FLAME RESISTANT COMPOSITE STRUCTURE

(71) Applicant: Momentive Specialty Chemicals Inc., Columbus, OH (US)

(72) Inventor: Terry D. LOY, San Clemente, CA (US)

(21) Appl. No.: 13/938,855

(22) Filed: Jul. 10, 2013

Related U.S. Application Data
(60) Provisional application No. 61/672,601, filed on Jul. 17, 2012.

(51) Int. Cl. C09D 5/18

(52) U.S. Cl. CPC C09D 5/18
USPC 428/425.3; 427/427.6; 427/428.01; 427/393.5; 428/524; 428/480

(57) ABSTRACT

Composites and methods for manufacturing composites are provided herein. In one embodiment, a composite structure is provided including a resin composite material and a surface layer disposed on the resin composite material, wherein the surface layer comprises a phenolic resin. In another embodiment, a vessel comprising a composite overwrapped vessel may be improved in regard to high temperature performance by applying thereto a surface layer comprising a phenolic resin.

### RELATED APPLICATION DATA

This application claims benefit to U.S. Provisional Application No. 61/672,601, filed Jul. 17, 2012, which the entire content of the application is incorporated by reference herein.

### BACKGROUND OF THE INVENTION

1. Field of the Disclosure

The invention relates to composites, methods for manufacturing the composites, and articles constructed from the composites.

2. Background of the Disclosure

High-performance fibers combined with thermoset or thermoplastic resins offer very high strength-to-weight ratios and are ideal for making lightweight storage vessels, pressure vessels and other composite structures and articles. Such vessels, for example, may have very thin walls, but can still be quite strong.

One disadvantage of such vessels and/or composite structures, especially those prepared with epoxy composites, is that they have very low flame resistance. Historically, flame retardancy has been imparted to such composites by incorporating therein flame retardant additives or components. Typical of such components are halogenated compounds containing fluorine, bromine, or chlorine, or chemical compounds which promote the formation of char. Brominated epoxy resins are examples of such flame retardant components. Flame retardant components can be incorporated into the composite by utilizing commercially available brominated epoxy resins along with an appropriate curative, or produced by curing conventional epoxy resins with a halogenate phenolic compounds such as, for example, tetrabrominated bisphenol-A (TBBPA). While this is effective in reducing the flammability of the composite, it has the disadvantage of increasing the density of the material and in turn increasing the weight of the resulting structure. This negates much of the benefit of using a fiber reinforced composite.

Additionally, imparting flame retardancy by the use of inorganic additives such as antimony, alumina, magnesium, and boron compounds additionally adds significant density to the matrix resin and creates issues with processing such as creating homogenous dispersions. In this approach the flame barrier used adds much less weight and less toxic smoke components to the article than modification of the entirety of the matrix resin in the composite structure. Other approaches include use of inorganic fillers such as aluminum trihydrate (ATH) that release water when heated. However, these hydrates of salts have a high density and add significant weight to the article. This also poses processing challenges such as adding to the viscosity and settling out of the resin. Non-polymer approaches included the overlay of metal/metal films and inorganic coatings to provide the flame barrier.

It would be desirable within the art to prepare pressure vessels, storage vessels and/or composite structures that both perform well at high temperatures and have surfaces that impart flame retardancy without the use, or substantially reduced use, of flame retardant additives. It is also desirable to avoid the use of inorganic overlays or cladding that adds prohibitive amounts of weight.

### SUMMARY OF THE DISCLOSURE

Embodiments of the invention are directed to composite structures and methods for manufacturing such composite structures.

In one aspect, a composite structure is provided including a resin composite material and a surface layer disposed on the resin composite material, wherein the surface layer comprises a phenolic resin.

In another aspect, a method for making a composite structure is provided including providing a resin composite material and applying a surface layer on the resin composite material, wherein the surface layer comprises a phenolic resin.

In another aspect, the invention, an article is provided comprising a structure having an outer resin composite layer and an overlay surface layer comprising a phenolic resin disposed on the resin composite layer.

In another aspect, the invention is a pressure vessel, storage vessel, composite structure and/or other article having an outer resin composite layer, and an overlay surface layer comprising a phenolic resin.

In another aspect the invention is a method of making an epoxy composite overwrapped pressure vessel, storage vessel, composite structure and/or other article having a surface layer comprising a phenolic resin, the method comprising applying to the surface of the pressure vessel, storage vessel, composite structure and/or other article an overlay surface layer comprising a phenolic resin wherein the cured resin, uncured resin, or partially cured resin structure itself serves the role of tooling for the overlay. This is manufacturing process driven and will allow for lower production time/higher efficiency since the sub-article will be sufficiently advanced or cured prior to the deposition and serve as the tool.

In still another aspect, the invention is a pressure vessel, other storage vessel, composite structure and/or other article comprising an epoxy composite overwrapped vessel, structure or article, wherein the epoxy composite is cured with phenolic resin and a polyphosphonate.

Another aspect of the invention is a method for preparing a pressure vessel, other storage vessel, composite structure and/or other article comprising over wrapping the vessel, structure or article using an epoxy composite wherein the epoxy composite is cured with phenolic resin and a polyphosphonate.

Another aspect of the invention is that the overlay allows the vessel, composite structure and/or other article to undergo load expansion without delaminating, and structure parts can undergo load deflection, elongations (within limits) without compromising the overlay benefit.

Another aspect of the invention is that the overlay provides a thermal barrier in the event of direct flame and lengthens the “fire life” of the articles versus vessels/structures that do not have the overlay protection.

Another aspect of the invention is that the smoke generation of the overlay is “more acceptable” and passes conventional industry targets for smoke, then goes to char and prevents smoke generation from the underlying epoxy or other resin matrix in the fire event. Strict standards for Flame, Smoke & Toxicity (FST) have been developed and are enforced in applications such as aircraft interiors or mass transit (trains) where human life can be endangered due to a fire event and time is required for egress. These include not only self-extinguishing characteristics of the materials employed but also limiting the amount of heat released, the amount of smoke generated as well as the toxicity of the smoke. These limitations preclude the use of brominated materials and heavy metals such as antimony that can generate corrosive acids such as hydrochloric or hydrobromic acid or other toxic emissions.

### BRIEF DESCRIPTION OF THE DRAWINGS

For a further understanding of the nature and objects of the present invention, reference may be had to the following detailed description taken in conjunction with the accompanying FIGURE, wherein:

FIG. 1 is a schematic cross section of a wall of a pressure vessel, storage vessel or other article of the application.

### DETAILED DESCRIPTION OF THE DISCLOSURE

Embodiments of the invention are directed to composite structures and methods for manufacturing such composite structures. In one aspect, a composite structure is provided including a resin composite material and a surface layer disposed on the resin composite material, wherein the surface layer comprises a phenolic resin. For purposes of this application, the term “composite structure” means any load bearing or secondary composite structure as the term is known and used in the art. For purposes of this application, the terms “overlay” or “overwrap” each refer to a surface layer.

The resin composite material may include an epoxy-containing material, a polyester-containing material, a vinyl ester-containing material, a polyurethane-containing material, a bismaleimide-containing material, a cyanate ester containing material, a dicyclopentadiene-containing material, and combinations thereof.

In the one embodiment of the composite a surface layer comprising a phenolic resin is applied to the resin composite material, such as an epoxy matrix resin. The surface layer may be one or more separate layers. The phenolic resins which may be used with the composite structure or the method of the application include any known phenolic resins that can bond to and/or cure over the resin composite material, such as the epoxy matrix resin. The applied phenolic resins may then perform as a hybrid structure which will char under flame exposure and the subsequent char will offer protection of the resin composite material, such as the epoxy matrix resin.

Suitable phenolics resins may include phenolic-formaldehyde resins selected from the group of novolac resins, resole resins, etherified resins, and combinations thereof.

For example, one such phenolic resin is a novolak resin. Generally the novolak resins, sometimes referred to in the art as two-stage resins, useful with the application can be prepared through polycondensation reaction of at least one aromatic hydrocarbon selected from, but not limited to, m-cresol, o-cresol, p-cresol, 2,5-xylenol, 3,5-xylenol, resorcinol, pyrogallol, phenol, trisphenol, o-ethyl phenol, m-ethyl phenol, p-ethyl phenol, propyl phenol, n-butyl phenol, t-butyl phenol, 1-naphthol, and 2-naphthol, with at least one aldehyde or ketone selected from, but not limited to, formaldehyde, acetaldehyde, propion aldehyde, benzaldehyde and furfural, in the presence of an acid. The resin is generally prepared using an excess of aromatic hydrocarbon.

When a resole resin is used with the method of the application, it may be an organic hydrocarbon and an aldehyde polycondensation product where the two components are present in nearly equal molar ratio to an excess of the aldehyde. The components useful for making the resole are the same as those designated as useful for preparing a novolac resin. Resoles are generally prepared with an excess of aldehyde in the presence of a basic catalyst.

In another embodiment of the method of the disclosure, the phenolic resin may be prepared using an alcohol. Suitable alcohols include, but are not limited to ethanol, propanol, butanol, pentanol, and the like. Such resins are sometimes referred to in the art as etherified resins.

The surface layer may further include a reinforcement material. The reinforcement material may comprise a fiber material including glass fibers, carbon fibers, boron fibers, Kevlar™/Aramid fibers, Spectra™ fibers, high density polyethylene (HDPE), quartz fibers, polyethylene, organic fibers, metal fibers, ceramic fibers, and combinations thereof. Organic fibers may include fibers from natural sources, for example, hemp, flax, Chine reed, jute, wood, and combinations thereof, among others. The reinforcement material may be in the form of a fiber, a mat, a fabric, a preform structure, strand bundles, or combinations thereof, a preimpregnated version of the aforementioned materials, or other reinforcing material structure. The surface layer with reinforcement material may have a thickness of 1 mm or greater, such as from about 1 mm to about 25 mm. The surface layer may be one or more layers, and may also be continuously deposited in two or more overlapping layers.

In another embodiment of the method of the application, the phenolic resins are applied with reinforcement material using application methods including filament winding, spraying chopped strands, applications of preimpregnated reinforcement materials (prepregs), hand layup, tow placement, press lamination, preform placement, and combinations thereof. Embodiments of surface layers with reinforcement material are believed to improve the structural strength of articles, such as vessels.

In one embodiment, the surface layer of the phenolic resin may cure at relatively low temperatures, such as from about 15° C. to about 35° C., for example, from about 20° C. to about 25° C. (ambient or room temperature), that are not detrimental to the resin composite material, such as an epoxy vessel, and also do not need a separate post-cure step. This lower temperature cure can be accomplished by utilizing as a catalyst in the surface layer material. Suitable catalysts include a single acid or a mixture of organic acids such as phenol or toluene sulfonic or phosphorous or phosphoric acids, for example, the PHENCAT™ catalyst series.

The composite structures, such as storage vessels or pressure vessels of the application, may be made using an epoxy resin. Epoxy resins are those resins containing at least one vicinal epoxy group. The epoxy resins useful as components of the thermosettable epoxy resin composition of the disclosure may be saturated or unsaturated, aliphatic, cycloaliphatic, aromatic or heterocyclic, and may be substituted with alkyl and other moieties.

The epoxy resin component utilized may be, for example, an epoxy resin or a combination of epoxy resins prepared from an epihalohydrin and a phenol or a phenol type compound, prepared from an epihalohydrin and an amine, prepared from an epihalohydrin and an a carboxylic acid, or prepared from the oxidation of unsaturated compounds.

In one embodiment, the epoxy resins utilized in the compositions of the application include those resins produced from an epihalohydrin and a phenol or a phenol type compound. The phenol type compounds include compounds having an average of more than one aromatic hydroxyl group per molecule. Examples of phenol type compounds include, but are not limited to dihydroxy phenols, biphenols, bisphenols, halogenated biphenols, halogenated bisphenols, hydrogenated bisphenols, alkylated biphenols, alkylated bisphenols, trisphenols, phenol-aldehyde resins, novolac resins (i.e. the reaction product of phenols and simple aldehydes, preferably formaldehyde), halogenated phenol-aldehyde novolac resins, substituted phenol-aldehyde novolac resins, phenol-hydrocarbon resins, substituted phenol-hydrocarbon resins, phenol-hydroxybenzaldehyde resins, alkylated phenol-hydroxybenzaldehyde resins, hydrocarbon-phenol resins, hydrocarbon-halogenated phenol resins, hydrocarbon-alkylated phenol resins or combinations thereof.

In another embodiment, the epoxy resin components utilized in the compositions of the disclosure may desirably include those resins produced from an epihalohydrin and bisphenols, halogenated bisphenols, hydrogenated bisphenols, novolac resins, and polyalkylene glycols or combinations thereof.

In still another embodiment, the epoxy resin components utilized in the thermosettable epoxy resin compositions of the disclosure may include those resins produced from an epihalohydrin and resorcinol, catechol, hydroquinone, biphenol, bisphenol-A, bisphenol-AP (1,1-bis(4-hydroxyphenyl)-1-phenyl ethane), bisphenol F, bisphenol K, tetrabromobisphenol-A, phenol-formaldehyde novolac resins, alkyl substituted phenol-formaldehyde resins, phenol-hydroxybenzaldehyde resins, cresol-hydroxybenzaldehyde resins, dicyclopentadiene-phenol resins, dicyclopentadiene-substituted phenol resins tetramethylbiphenol, tetramethyl-tetrabromobiphenol, tetramethyltribromobiphenol, tetrachlorobisphenol-A, or combinations thereof.

In another embodiment, the epoxy resin components utilized in the thermosettable epoxy resin composition of the present application include those resins produced from an epihalohydrin and an amine. Suitable amines may include diamino diphenylmethane, aminophenol, xylene diamine, anilines, and the like, or combinations thereof. In another embodiment, the epoxy resins utilized in the embodiments of the disclosure include those resins produced from an epihalohydrin and a carboxylic acid. Suitable carboxylic acids may include phthalic acid, isophthalic acid, terephthalic acid, tetrahydro- and/or hexahydrophthalic acid, endomethylene tetrahydrophthalic acid, isophthalic acid, methyl hexahydrophthalic acid, and the like or combinations thereof.

In another embodiment, the epoxy resin components utilized include those resins produced from an epihalohydrin and compounds having at least one aliphatic hydroxyl group. In this embodiment, it is understood that such resin compositions produced contain an average of more than one aliphatic hydroxyl groups. Examples of compounds having at least one aliphatic hydroxyl group per molecule include aliphatic alcohols, aliphatic diols, polyether diols, polyether triols, polyether tetrols, any combination thereof and the like. Also suitable are the alkylene oxide adducts of compounds containing at least one aromatic hydroxyl group. In this embodiment, it is understood that such resin compositions produced contain an average of more than one aromatic hydroxyl groups. Examples of oxide adducts of compounds containing at least one aromatic hydroxyl group per molecule may include, but are not limited to, ethylene oxide, propylene oxide, or butylene oxide adducts of dihydroxy phenols, biphenols, bisphenols, halogenated bisphenols, alkylated bisphenols, trisphenols, phenol-aldehyde novolac resins, halogenated phenol-aldehyde novolac resins, alkylated phenol-aldehyde novolac resins, hydrocarbon-phenol resins, hydrocarbon-halogenated phenol resins, or hydrocarbon-alkylated phenol resins, or combinations thereof.

In another embodiment the epoxy resin component may be an advanced epoxy resin which is the reaction product of one or more epoxy resins components, as described above, with one or more phenol type compounds and/or one or more compounds having an average of more than one aliphatic hydroxyl group per molecule as described above. Alternatively, the epoxy resin may be reacted with a carboxyl substituted hydrocarbon. A carboxyl substituted hydrocarbon which is described herein as a compound having a hydrocarbon backbone, preferably a C1-C40 hydrocarbon backbone, and one or more carboxyl moieties, preferably more than one, and most preferably two. The C1-C40 hydrocarbon backbone may be a straight- or branched-chain alkane or alkene, optionally containing oxygen. Fatty acids and fatty acid dimers are among the useful carboxylic acid substituted hydrocarbons. Included in the fatty acids are caproic acid, caprylic acid, capric acid, octanoic acid, VERSATIC™ acids, available from Momentive Specialty Chemicals, Inc., Houston, Tex., and decanoic acid, lauric acid, myristic acid, palmitic acid, stearic acid, palmitoleic acid, oleic acid, linoleic acid, linolenic acid, erucic acid, pentadecanoic acid, margaric acid, arachidic acid, and dimers thereof.

In still another embodiment, the epoxy resin component may be the reaction product of a polyepoxide and a compound containing more than one isocyanate moiety or a polyisocyanate. In some embodiments, the epoxy resin that may be produced in such a reaction is an epoxy-terminated polyoxazolidone.

The phenolic resins may be applied to the resin composite material, such as an epoxy matrix, in any way known to be useful to those of ordinary skill in the art of preparing articles, such as pressure vessels.

In one embodiment, the phenolic resin, such as a resole resin, is applied as a layer by painting, spraying, rolling, and combinations thereof on the resin composite material. The resin composite material may be the outermost layer of an article or may comprise the article. Examples of articles are vessels, such as storage vessels and pressure vessels, panels, cylindrical structures including piping, molded composite parts, and construction articles including structural beams, support structures, structural panels, beams, floor grates, and ballistic panels, among others. For example, the resin composite material may be an epoxy material disposed on a vessel surface, or the vessel itself may be made of an epoxy material. In embodiments such as this, it has been observed that the resulting phenolic layer substantially improves the flame resistance of the composite material.

In another embodiment of the method of the application, the phenolic resins are applied with fiber reinforcing using application methods including filament winding, spraying chopped strands, applications of preimpregnated reinforcement materials (prepregs), hand layup, tow placement, press lamination, preform placement, and combinations thereof. It is believed that these embodiments also improve the structural strength of the articles, such as vessels.

In the embodiments utilizing a process such as filament winding or spraying chopped strands, the phenolic resin may be cured as the process proceeds. Ideally the phenolic resin may cure at relatively low temperatures, such as from about 15° C. to about 35° C., for example, from about 20° C. to about 25° C. (ambient or room temperature), that are not detrimental to the epoxy vessel and also do not need a separate post-cure step. The cure may be accomplished by utilizing a catalyst. Suitable catalysts include a single acid or a mixture of organic acids such as phenol or toluene sulfonic or phosphorous or phosphoric acids, for example, the PHENCAT™ catalyst series.

In the practice of one embodiment of the method of the application, a vessel is prepared by over wrapping the vessel using the resin composite material, such as an epoxy composite material, with the resin composite material is cured with phenolic resin and a polyphosphonate. The phenolic resins useful with this embodiment of the application are the same as those listed above. The polyphosphonates useful include those known to one of ordinary skill in the art in preparing flame retardant resins. For example FRX™ OL-3001 is one such compound and is commercially available from FRX Polymers, Inc.

Articles, such as vessels, can be prepared using the resins described above. The resulting composite surface of the articles is substantially more flame resistant than an otherwise unmodified article. In one embodiment the article contains an epoxy-containing material, a polyester-containing material, a vinyl ester-containing material, a polyurethane-containing material, a bismaleimide-containing material, a cyanate ester containing material, a dicyclopentadiene-containing material, and combinations thereof, other composite surface or any subset thereof. In another embodiment, the article is a vessel which contains an epoxy composite surface.

One embodiment of the application is an epoxy composite overwrapped storage vessel or pressure vessel. Such vessels may be made using any method known to those of ordinary skill in the art to be useful. These vessels may contain an inner liner such as with metal liner or a polymeric liner, such as HDPE (high density polyethylene), PP (polypropylene), PS (polystyrene), poly-DCPD (poly-dicyclopentadiene), and the like. In some embodiments, the vessels have no liner at all.

On one embodiment of the article, such as pressure vessels, the article may have an outer layer of the resin composite material useful made with fibers wound thereon in an epoxy matrix resin prior to the application of a phenolic resin. The fibers may be the same reinforcing materials and in the same forms as described for the surface layer herein. Examples of such outer layers of articles are found in U.S. Reissue application 38,433 to Seal, et al., and U.S. Pat. No. 6,953,129, which both disclose preparing vessels. These references are fully incorporated herein by reference in their entirety.

For the purposes of this application, the term “pressure vessel” means any tank, pipe or flange that is used to store or transport materials at pressures greater than atmospheric.

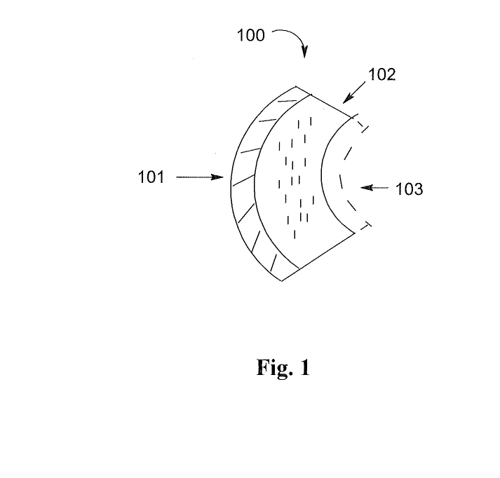

Turning to FIG. 1, reference number 100 is a cross-sectional view of the wall of a pressure vessel of the application. Reference number 103 represents a metal liner wherein the subject embodiment has a metal liner. Otherwise this area would be the interior of the pressure vessel. Reference number 102 represents one embodiment of a resin composite material, for example, an epoxy resin matrix, forming a layer on the liner 103. In some embodiments this resin composite material is reinforced.

Reference number 101 represents an outer layer comprising a phenolic resin. In some embodiments, this is a layer of resin only. In other embodiments includes a fiber, matt, or other reinforcing material. Materials useful as reinforcing materials for the application include, but are not limited to, glass fibers, carbon fibers, boron fibers, Kevlar™/Aramid fibers, Spectra™ fibers, high density polyethylene (HDPE), quartz fibers, polyethylene, organic fibers, metal fibers, ceramic fibers, and combinations thereof. Kevlar fibers are commercially available from E. I. du Pont de Numours and Co., and Spectra fibers are commercially available from Honeywell International Inc.

### EXAMPLES

The following examples and comparative examples are provided to illustrate certain embodiments of the invention. The examples are not intended to limit the scope of the application and they may not be so interpreted. Amounts are in weight to weight (w/w) parts or w/w percentages unless otherwise indicated.

Samples were prepared for two embodiment of the invention. In a first embodiment, a phenolic resin coated epoxy composite material was prepared by a coating method. In a second embodiment, a fiber reinforced phenolic layer was formed on an epoxy composite material. The samples were prepared as follows:

For the Examples, the following materials were used: 0.5″×7″ panel of an epoxy composite was made from EPIKOTE™ resin MGS RIMR 135 and EPIKURE™ curing agent MGS RIMH 137 epoxy material and E-glass fibers; CELLOBOND™ FRP J2027L phenolic resin commercially available from Momentive Specialty Chemicals Inc, of Columbus, Ohio; CELLOBOND™ Phencat 10 catalyst commercially available from Momentive Specialty Chemicals Inc, of Columbus, Ohio; Style 2116 Plain weave fiberglass fabric, 106 g/m² from BFG Industries of Greensboro, N.C.; and a six (6) cm long single-opening plastic tube.

The epoxy composite panel was formed by an infusion process. Dry fiberglass fabric, OCV L1020 commercially available from OCV Technical Fabrics of Brunswick, Me. was placed in a metal mold. The mold was closed and a liquid epoxy resin of EPIKOTE™ resin MGS RIMR 135 and EPIKURE™ curing agent MGS RIMH 137 (both of which are commercially available from Momentive Specialty Chemicals of Columbus, Ohio), was injected into the closed metal mold. When the mold was filled with the liquid epoxy resin, the mold was heated to the cure temperature of about 70° C. for 6 hours until cured. Upon cooling of the mold, the mold was opened and the cured epoxy composite was removed. The fiberglass content of the epoxy composite was from 65% to 70% by weight. The epoxy composite was then sectioned into 0.5″×7″ panels or strips.

### Example 1

### Phenolic Resin Coated Epoxy Composite Material

Samples of the phenolic resin coated epoxy composite material were prepared as follows. The phenolic material of Cellobond FRP J2027L was blended with Cellobond Phencat 10 catalyst as 100 parts of phenolic resin and 10 parts catalyst. The mixed phenolic material was then poured into the plastic tube. The epoxy composite panel was placed in the plastic tube and the mixed phenolic material was disposed on the epoxy composite panel. The epoxy composite panel was exposed to the mixed phenolic material for thirteen minutes and allowed to dry for three hours. The epoxy composite panel was then placed again in the plastic tube and a second coat of the mixed phenolic material was disposed on the epoxy composite panel. The epoxy composite panel was then cured for 72 hours at ambient conditions.

### Example 2

### Fiber Reinforced Phenolic Layered Epoxy Composite Material

Samples of the fiber reinforced phenolic resin coated epoxy composite material were prepared as follows. A 7″ long sleeve was made from the thin woven fiberglass and then an epoxy composite panel was placed into the sleeve. The phenolic material of Cellobond FRP J2027L was blended with Cellobond Phencat 10 catalyst as 100 parts of phenolic resin and 8 parts catalyst. The mixed phenolic material was then poured into the plastic tube. The sleeved epoxy composite panel was placed in the plastic tube and the mixed phenolic material was disposed on the sleeved epoxy composite panel. The sleeved epoxy composite panel was exposed to the mixed phenolic material for thirteen minutes and allowed to dry for three hours. The epoxy composite panel was then placed again in the plastic tube and a second coat of the mixed phenolic material was disposed on the sleeved epoxy composite panel. The resulting epoxy composite panel was then cured for 72 hours at ambient conditions.

The samples from Examples 1 and 2 along with an untreated epoxy composite panel as a control were then subjected to a UL94 flame resistance test (Tests for Flammability of Plastic Materials for Parts and Devices and Appliances: 6^{th} Edition, Issued Mar. 28, 2013, which is also the IPC-TM-650 test from the Institute of Interconnecting and Packaging Electronic Circuits of Northbook, Ill.). Five samples of the control and the products of Example 1 and four samples of the products of Example 2 were prepared and submitted for UL 94 testing with the following results as shown in Table 1.

TABLE 1

| | Sample | | | | |
|---|---|---|---|---|---|
| | Thickness | First Burn | Second Burn | Burn to | Pass/Fail |
| Sample No. | (mm) | (t_{1 sec}) | (t_{2 sec}) | Clamp | UL 94 test |
| Control-1 | 3.025 | 115 | N/A | Yes | Fail |
| Control-2 | 3.025 | 160 | N/A | Yes | Fail |
| Control-3 | 3.023 | 147 | N/A | Yes | Fail |
| Control-4 | 3.022 | 152 | N/A | Yes | Fail |
| Control-5 | 3.019 | 164 | N/A | Yes | Fail |
| Ex. 1-1 | 5.505 | 0.0 | 153 | No | Fail |
| Ex. 1-2 | 5.409 | 0.0 | 0.0 | No | Fail |
| Ex. 1-3 | 4.400 | 0.0 | 150 | Yes | Fail |
| Ex. 1-4 | 4.743 | 0.0 | 150 | Yes | Fail |
| Ex. 1-5 | 4.739 | 0.0 | 150 | No | Fail |
| Ex. 2-1 | 4.806 | 0.0 | 0.0 | No | Pass |
| Ex. 2-2 | 4.417 | 0.0 | 0.0 | No | Pass |
| Ex. 2-3 | 4.871 | 0.0 | 0.0 | No | Pass |
| Ex. 2-4 | 4.468 | 0.0 | 0.0 | No | Pass |

The control samples illustrate from the test that the untreated epoxy compositions are flammable. All control samples were burned during the first burn process, and no second burn process could be performed. The Example 1 materials of the phenolic coating were not burned in the first burn process, and some of the samples did burn in the second process. Additionally, as shown in the “Burn to Clamp” category, half of the Example 1 materials that did burn only partially burned. Thus, the phenolic resin coated epoxy composite material had improved flame resistance as compared to an untreated epoxy composite material.

The Example 2 materials of the fiber reinforced phenolic coating were not burned in the first burn process, and, were not burned in the second process. Additionally, all the samples passed the UL 94 test for flammability. Thus, the fiber reinforced phenolic layered epoxy composite material had improved flame resistance as compared to an untreated epoxy composite material.

### Structural Example

A pressure vessel or other sample may be tested at least in accordance with ANSI/CSA NGV2-2007, commonly referred to in the art as the “bonfire” test. This sample may be made by filament winding Epon™ epoxy resin 862, commercially available from Momentive Specialty Chemicals Inc., cured using LS-81K anhydride, commercially available from Lindau Chemicals, Inc., on the sample, such as the vessel, and then further prepared by applying to the surface thereof a layer of polymer or polymer/fiber using a formulation including Cellobond™ J2027L phenolic resin cured using Cellobond PHENCAT™ 10 catalyst, both components being products of Momentive Specialty Chemicals Inc.

The size and shape of the vessel or composite may any one of those known in the art. The amount and thickness of phenolic resin is that which is effective to delay the failure of the underlying composite, when compared to a vessel or composite not containing the phenolic resin overlayer (comparative). The filament wound epoxy layer, when cured, is about 12 mm thick or more. In another embodiment, the wound resin composite layer, when cured is about 12 mm thick or more.

The phenolic layer, when cured, is at a thickness effective to delay the failure rate of the underlying composite layer, having no phenolic overlay (comparative), by at least 10%. In one embodiment, the failure delay is at least 20%. In another embodiment, the failure delay is at least 10% to at least 100%. In one embodiment, when cured, the thickness of the phenolic layer is about 2 mm or greater, and may be between about 2 mm to about 20 mm. In one embodiment for every 25 mm of composite layer, there is about 3 mm of phenolic overlay.

While the present invention has been described and illustrated by reference to particular embodiments, those of ordinary skill in the art will appreciate that the invention lends itself to variations not necessarily illustrated herein.

What is claimed is:

1. A composite structure comprising:
a resin composite material; and
a surface layer disposed on the resin composite material, wherein the surface layer comprises a phenolic resin.

2. The composite of claim 1, wherein the resin composite material includes an epoxy-containing material, a polyester-containing material, a vinyl ester-containing material, a polyurethane-containing material, a bismaleimide-containing material, a cyanate ester containing material, a dicyclopentadiene-containing material, and combinations thereof.

3. The composite of claim 1, wherein the resin composite material further comprises fibers.

4. The composite of claim 1, wherein the phenolic resin is a material selected from the group of novolak resin, resole resin, etherified resin, and combinations thereof.

5. The composite of claim 1, wherein the surface layer further comprises a reinforcement material.

6. The composite of claim 5, wherein the reinforcement material comprises a fiber material selected from the group of glass fibers, carbon fibers, boron fibers, Kevlar™/Aramid fibers, Spectra™ fibers, high density polyethylene (HDPE), quartz fibers, polyethylene, organic fibers, metal fibers, ceramic fibers, and combinations thereof.

7. The composite of claim 1, wherein the resin composite layer comprises an article, a surface of an article, or both.

8. The composite of claim 7, wherein the article is selected from the group consisting of a vessel, a panel, a cylindrical structure, a molded composite part, a construction article and combinations thereof.

9. The composite of claim 1, wherein the surface layer further comprises a curing catalyst.

10. A method for making a composite structure, comprising;
providing an resin composite material; and
applying a surface layer on the resin composite material, wherein the surface layer comprises a phenolic resin.

11. The method of claim 10, wherein the applying the surface layer comprises process selected from the group of a painting, spraying, rolling, and combinations thereof.

12. The method of claim 10, wherein the resin composite material includes an epoxy-containing material, a polyester-containing material, a vinyl ester-containing material, a polyurethane-containing material, a bismaleimide-containing material, a cyanate ester containing material, a dicyclopentadiene-containing material, and combinations thereof.

13. The method of claim 10, wherein the resin composite material further comprises fibers.

14. The method of claim 10, wherein the phenolic resin is a material selected from the group of novolak resin, resole resin, etherified resin, and combinations thereof.

15. The method of claim 10, wherein the surface layer further comprises a reinforcement material.

16. The method of claim 15, wherein the reinforcement material comprises a fiber material selected from the group of glass fibers, carbon fibers, boron fibers, Kevlar™/Aramid fibers, Spectra™ fibers, high density polyethylene (HDPE), quartz fibers, polyethylene, organic fibers, metal fibers, ceramic fibers, and combinations thereof.

17. The method of claim 15, wherein the applying the surface layer comprises process selected from the group of a filament winding, spraying chopped strands, applications of prepregs, and combinations thereof.

18. The method of claim 10, wherein the surface layer further comprises a curing catalyst.

19. The method of claim 10, further comprising curing the surface layer.

20. An article, comprising
a structure having an outer resin composite layer; and
an overlay surface layer comprising a phenolic resin disposed on the resin composite layer.
